(19) United States
(12) Patent Application Publication
(10) Pub. No.: US 2020/0291923 A1
(43) Pub. Date: Sep. 17, 2020

(54) Advanced Wind Energy Generator

(71) Applicant: Rohan Vishnubhai Patel, Bensalem, PA (US)

(72) Inventor: Rohan Vishnubhai Patel, Bensalem, PA (US)

(21) Appl. No.: 15/017,647

(22) Filed: Feb. 7, 2016

(51) Int. Cl. F03D 7/06; F03D 15/00; F03D 3/00; F03D 9/25

(52) U.S. Cl. CPC F03D 7/06; F03D 9/25; F03D 3/005; F03D 15/00

(57) ABSTRACT

Basically the Advanced Wind Energy Generator is a vertical wind mill with moveable doors. By closing the doors on apparatus moving with wind, it can harvest more wind energy. Same doors will open as soon as they travel against blowing wind which will minimize the drag. This system will make moveable door wind mill quite yet effective.

### RELATED APPLICATIONS

The current application claims benefit of U.S. Provisional Patent Application 62/115,060 filed Feb. 11, 2015.

### FIELD OF THE INVENTION

The present invention relates generally to a wind powered generator, more particularly to a quiet wind turbine with moving doors that maximize efficiency and minimize drag. The present invention is a wind turbine with moving doors that rotate between an open and closed position by the flow of ambient air, such that the doors are opened when moving against the wind and closed when moving in line with the wind.

### BACKGROUND OF THE INVENTION

The present invention is a windmill with moveable doors that block air passage while rotating in the direction towards wind. The doors open up when they are travelling in the direction opposite of wind motion. Opened door allow easy escape for wind, therefore limiting drag and increasing efficiency. Closed doors block the wind harnessing kinetic energy from wind and spinning the rotor. Due to the closed door design on one side and open door design on the side facing into the wind the net power output of the generator is increased. This design allows the use of heavier generator with turbines that are smaller than the turbines used in traditional wind powered generators.

### SUMMARY

Disclosed is an Advanced Wind energy harvesting system. The energy harvesting system includes plurality of wind apparatus with each having move than one moveable doors. The movable doors can help harvest more energy by restricting wind's path, and minimize the resistance by opening doors while moving against the direction of wind. Additionally the door may be operated with help of stoppers and centrifugal force. The system also can be operated by having gear system which can open and close the doors. The gear system will be off center gears which will close the doors of wind harnessing apparatuses moving with direction of wind and open when it starts moving against the blowing wind.

### BRIEF DESCRIPTION OF THE DRAWINGS

FIG. 1 is a front view of the Advanced Wind Energy Generator.

FIG. 2 is a rear view of the present invention.

FIG. 3 is a left view of the present invention.

FIG. 4 is a right view of the present invention.

FIG. 5 is a top view of the present invention.

FIG. 6 is a bottom view of the present invention.

FIG. 7 is a perspective view of the present invention.

FIG. 8 is a top view of the present invention illustrating the movement of the doors and linkage assembly as the turbine is moved by wind.

### DETAIL DESCRIPTIONS OF THE INVENTION

All illustrations of the drawings are for the purpose of describing selected versions of the present invention and are not intended to limit the scope of the present invention.

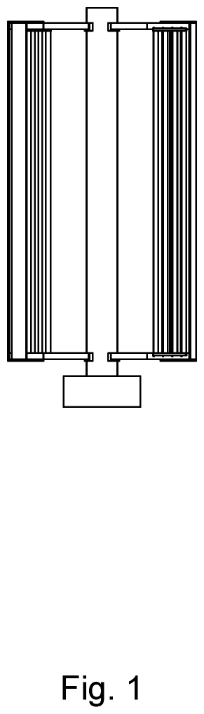

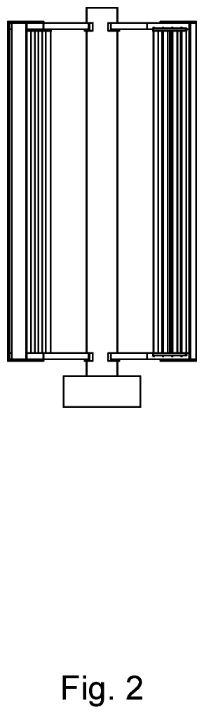

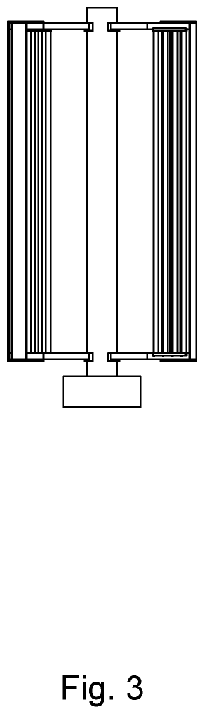

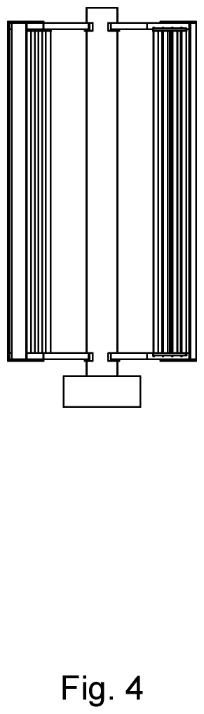

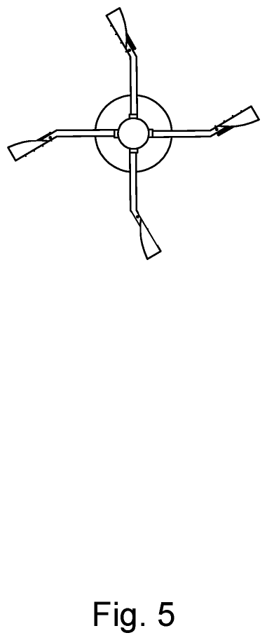

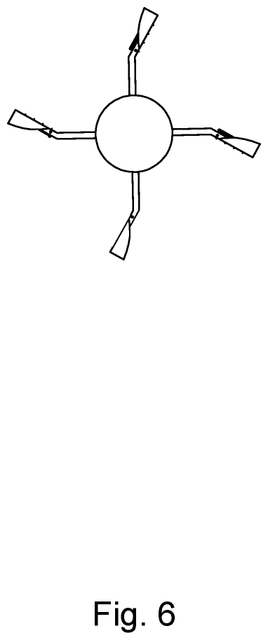

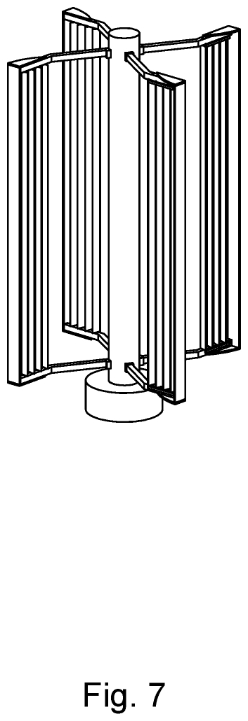

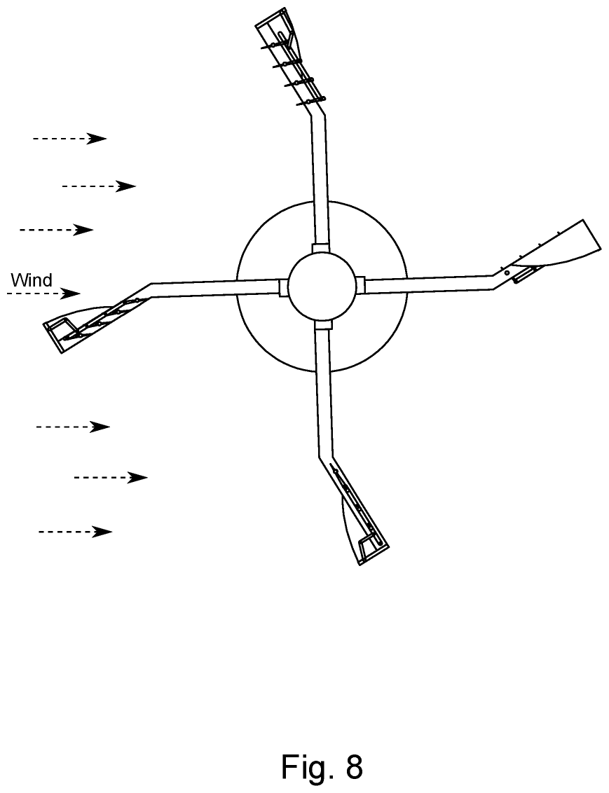

The following descriptions are in reference to FIG. 1 through FIG. 8. The preferred embodiment of the present invention, the Advanced Wind Energy Generator, is a device that makes use of pivoting doors and actuating linkages to create a quiet, high efficiency, wind-powered generator that suffers no substantial damage while operating in high wind environments. The Advanced Wind Energy Generator comprises a base, a central axis, a plurality of connective beams, and a plurality of wind harnessing apparatuses. It is an aim of the present invention to provide a turbine that maximizes the amount of torque transferred to the gearbox. This is achieved through the use of movable doors that are actuated by the flow of ambient air. That is, each blade of the Advanced Wind Energy Generator is designed with a plurality of moving doors that pivot into a closed position when in line with of the flow of air; providing the necessary torque to rotate the turbine. As the blades move out of the line of airflow the pivoting doors are pushed into an open position to reduce drag; enabling the turbine to transfer the maximum amount of wind generated torque directly into the gearbox. In the preferred embodiment of the present invention the wind turbine is designed as a vertical axis windmill with wind harnessing apparatuses that rotate around the central axis. In an additional embodiment the Advanced Wind Energy Generator is designed to rotate about a horizontal axis.

It is an aim of the present invention to provide a wind turbine that achieves quiet operation through the use of actuating linkages that prevent the plurality of moving doors from slamming as they are moved into a closed position by the flow of ambient air. The present invention is a scalable apparatus with dimensions which are modified to perform in a variety of operating conditions. For example, the Advanced Wind Energy Generator is designed to deliver energy to systems ranging in size from handheld devices to entire building complexes. Additionally, the base mount is designed to connect the Advanced Wind Energy Generator to the roofs of buildings, enable the apparatus to function as a free standing turbine, connect the device to vehicles, or to mount the device in any position suitable for harnessing the flow of ambient air to generate electricity. The Advanced Wind Energy Generator is manufactured using rigid lightweight materials that minimize the energy required to actuate the plurality of wind harnessing apparatuses such as aluminum, carbon fiber, metamaterials, plastics, composites and the like; thereby maximizing efficiency.

In the preferred embodiment of the present invention the base is designed to function as a transfer station that translates mechanical motion of the wind turbine into electrical energy. This energy may be used to power external devices or transferred to a battery for storage. To that end the base is comprised of a generator, an axis connection, a power conduit, and a base mount. The generator further comprises a gearbox that is mechanically coupled to the central axis creating the transfer point for motion into electricity. Rotary motion of the central axis is used to actuate the gearbox such that electricity is generated and transferred to external devices through the power conduit. The axis connection is a hole through the face of the base opposite the base mount. In the preferred embodiment of the present invention, the axis connection maintains the central axis in low friction communication with the base, such that the central axis cannot be removed by force applied along its central axis, and maintains a substantially vertical orientation throughout rotation. In one embodiment of the present invention the axis connection makes use of magnetic levitation technology to maintain the central axis in a primarily low friction position. In an additional embodiment the axis connection is designed with bearings and the like which enable smooth rotary motion of the central axis.

In the preferred embodiment of the present invention, the power conduit extends from the base to maintain the generator in electrical communication with external devices. Energy created by the Advanced Wind Energy Generator is transferred out of the generator, through the power conduit, and into connected devices. The base mount is designed to maintain the Advanced Wind Energy Generator in a fixed position while the central axis and plurality of wind harnessing apparatuses are actuated by the movement of ambient air. In one embodiment the base mount makes use of fasteners to affix the Advanced Wind Energy Generator to the roof of a building or vehicle. In an additional embodiment the base mount functions as a foundation that enables the present invention to stand in an open area.

In an exemplar embodiment of the present invention, the central axis is a rigid member that extends from the base and functions as the axis about which the plurality of wind harnessing apparatuses rotates. The central axis further comprises a base connector and a plurality of beam connections. It is an aim of the present invention to provide a base connector which mates to the axis connection such that the highest amount of mechanical motion is transformed into electrical energy. Pluralities of beam connections are positioned around the exterior of the central axis, such that pluralities of connective beams are permanently attached to the central axis. The connection created between the beam connections of the central axis and the central connector of each connective beam is established through the use of fasteners such as threaded members, welds, industrial strength adhesives, and the like.

In the preferred embodiment of the present invention, a plurality of connective beams extends between the central axis and the plurality of wind harnessing apparatuses. It is an aim of the present invention to provide connective beams that support connected wind harnessing apparatuses, such that the beams do not produce a significant amount of drag as the turbine rotates. In the preferred embodiment of the present invention, the connective beams are spaced around the perimeter of the central axis at even intervals such that the maximum amount of wind energy is harnessed and subsequently transformed into electrical energy. Each of the plurality of connective beams is an identical rigid structure that extends between the central axis and a single wind harnessing apparatus. In a preferred embodiment of the present invention, each connective beam has a harness connector that is angled to connect to the beam joint of an attached wind harnessing apparatus, such that the maximum amount of torque is generated by movement of the ambient air.

The Advanced Wind Energy Generator is designed with a plurality of wind harnessing apparatuses that function to maximize generated torque, and minimize blade drag. Each of the plurality of wind harnessing apparatuses comprises one or more identical harnessing apparatuses. The harnessing apparatuses further comprise a beam joint, a plurality of pivoting doors, an actuating linkage, and a wind catch. It is an aim of the present invention to provide a wind harnessing apparatus that maximizes torque and reduces drag through the use of movable doors which form solid wind traps while in the closed position, and enable air to easily pass through the space between the doors while in the open position. To that end the harnessing apparatus is designed as an open frame which becomes a closed wind trap when inline with the flow of ambient air. In one embodiment of the present invention the connection between the beam joint and harness connector is established, such that the wind harness can be removed and replaced. In a separate embodiment, the wind harness is permanently affixed to the connective beam. In the preferred embodiment of the present invention, the plurality of pivoting doors are connected to the frame of the wind harnessing apparatus by a pivot system and connected to the linkage assembly at the linkage connection. The doors are free to rotate about the pivoting system and are prevented from slamming shut through the use of the actuating linkage. The pivot system further comprises a rod that extends from the doors into the frame of the wind harnessing apparatus, and a set of bearings that enable the doors to rotate with minimal resistance.

In the preferred embodiment of the present invention, the plurality of pivoting doors are spaced along the frame of the harnessing apparatus, such that even in the closed position the doors do not come into contact with one another; thus precluding the possibility of slamming. It is an aim of the present invention to provide pivoting doors that are connected to an assembly linkage which causes the doors to move in concert. That is, the linkage connection mates to the door connection member such that motion of one door is transferred to the remaining doors; enabling the doors to function as a coordinated wind directing system. In the preferred embodiment of the present invention pivoting doors in the closed position do not touch, while forming a sufficiently solid wind directing member, thus limiting the amount of air that passes through the gaps between each door. In one embodiment of the present invention, the ends of each door are equipped with flexible members that bridge the gaps between doors preventing air flow through said gaps In this embodiment the pliability of the flexible extension prevent the creation of unwanted noise as the pivoting doors move into the closed position. In the open position the plurality of pivoting doors rotates between zero and ninety degrees relative to the frame of the wind harnessing apparatus.

It is an aim of the present invention to provide an actuating linkage that regulates the rotation of the plurality of connected pivoting doors. To that end the actuating linkage is connected to each of the plurality of pivoting doors attached to a single harnessing apparatus, and further comprises a door connection member, and a slam prevention member. In the preferred embodiment of the present invention, the actuating linkage connects the plurality of pivoting doors to the wind catch, such that the actuating linkage causes motion of one door to be transferred to the other connected doors, and all of the doors are prevented from slamming shut or rotating in an uncontrolled manner.

It is an aim of the present invention to provide a door connection member that governs the movement of the plurality of pivoting doors. The door connection member further comprises a wind compensation assembly. The door connection member extends between the linkage connections of each pivoting door. This door connection member enables the doors to rotate and prevents the doors from slamming shut. In the preferred embodiment of the present invention, the wind compensation assembly enables each pivoting door to pivot slightly past the closed position to compensate for excessive wind pressures. That is, while the pivoting doors are in the closed position are substantially parallel to the frame of the harnessing apparatus during normactual conditions; the wind compensation assembly enables the pivoting doors to pivot into a position that lets air escape preventing damage to the Advanced Wind Energy Generator. Once the excessive wind pressure is relieved, the pivoting doors are pulled back towards the closed position and function as normal.

In the preferred embodiment of the present invention, the slam prevention assembly is the leg of the actuating linkage that extends from the wind catch to the door connection member and slows the motion of the pivoting doors as they near the closed position. The slam prevention member further comprises a wind catch connection, a hinge, and a slam prevention beam. The wind catch connection extends from the linkage connection of the rigid wind catch, forming the anchor point for the actuation linkage. This connection further comprises a dampener which slows the motion of the wind catch connection and attached door connection member to prevent the possibility of a slam occurring. In the preferred embodiment of the present invention the dampener does not impede the motion of the pivoting doors beyond preventing a slam. That is, motion of the plurality of pivoting doors is completely controlled by the flow of ambient air until the doors are within a short distance of the closed position. At this point the dampener is engaged to prevent the doors from slamming. In an exemplar embodiment of the present invention the dampener is manufactured using springs, pistons, rubber stoppers, and other known motion dampening devices. The slam prevention beam extends form the end of the wind catch connection opposite the wind catch to form a hinge. The end of the slam prevention bar opposite the wind catch connection is connected to the door connection member. This connection is established such that motion of the pivoting doors is transferred through the door connection member, into the slam prevention beam, and pivots the wind catch connection.

In the preferred embodiment of the present invention the wind catch is a rigid panel that extends at ninety degrees from the frame of the harnessing apparatus. Air flow causes the pivoting doors to close such that the air is directed towards the wind catch which causes the wind harnessing apparatuses to rotate the Advanced Wind Energy Generator, thus producing electrical energy. In one embodiment of the present invention flat panels extend from the end of the wind catch towards the frame of the wind harnessing apparatus, further increasing the efficiency of the Advanced Wind Energy Generator. In an additional embodiment the wind catch is a pivoting panel that rotates with the direction of the wind in a similar manner to the pivoting doors, such that the wind harnessing apparatuses provide a minimal amount of drag when moving against the direction of the wind.

Although the invention has been explained in relation to its preferred embodiment, it is to be understood that many other possible modifications and variations can be made without departing from the spirit and scope of the invention.

What is claimed is:

1. An advanced wind energy generator comprises:
a base;
a central axis;
a plurality of harnessing apparatuses; and
a plurality of moving doors.

2. The advanced wind energy generator as claimed in claim 1 comprises:
each of the plurality of wind harnessing apparatuses comprises a frame, a plurality of pivot doors, stopper linkage, and a wind catch;
the plurality of pivot doors being distributed along the width of the frame, wherein a minor gap is created in between adjacent pivot doors;
each of the plurality of pivot doors being pivotably attached within the frame;
the wind catch being positioned around the frame;
the wind catch being adjacently connected to the frame, opposite the central axis; and,
the actuating linkage being operatively connected to each of the plurality of pivot doors, where in, the actuating linkage stops the door shut while wind harnessing apparatuses is rotating in direction of wind.

3. The advanced wind energy generator as claimed in claim 1 comprises;
each of the plurality of wind harnessing apparatuses further comprises dampener; and,
the dampener being integrated into the stopper linkage.

4. The advanced wind energy generator as claimed in claim 3 comprises;
each of the plurality of wind harnessing apparatuses further comprises dampener; where in
the dampener opens door past its closing angle in order to release excessive wind force in case of higher speed wind that can damage the frame of wind apparatuses.

5. The advanced wind energy generator as claimed in claim 3 comprises, wherein the dampener of each of the wind harnessing apparatuses slows the motion of the wind catch connection, preventing slamming and the production of noise.

6. The advanced wind energy generator as claimed in claim 1 comprises:
the base comprises an electric generator and a gearbox;
the input shaft of the gearbox is operationally connected to the central axis;
the output shaft of the gearbox is operationally coupled to the electric generator;

7. The advanced wind energy generator as claimed in claim 6 further comprises;
A torsion spring between the central axis and the generator assembly; wherein,
The torsion spring helps smoothening out the pulses of uneven blowing wind.

8. The advanced wind energy generator as claimed in claim 1 comprises, wherein the base is rigidly anchored to a surface such as a device, a vehicle, a roof of a building, or to the ground.

9. The advanced wind energy generator as claimed in claim 1 comprises, wherein the flow of ambient air applies a lateral force on the plurality of wind harnessing apparatuses and applies a torque force on the central axis resulting in the central axis.

10. The advanced wind energy generator as claimed in claim 2 comprises, wherein each of the pivot doors rotate into a closed position when in line with the flow of ambient air to create a torque and rotate into an open position when the pivot doors move out of the flow line of ambient air.

11. A advanced wind energy generator comprises:
a base;
a central axis;
a plurality of harnessing apparatuses; and
a plurality of gear controlled pivoting doors from center.

12. The advanced wind energy generator as claimed in claim 11 comprises;
each of the plurality of wind harnessing apparatuses further comprises gear controlled door opener; and,
the gear controlled door opener being integrated into the actuating linkage.

13. The advanced wind energy generator as claimed in claim 11 comprises, wherein the gear controlled door opener of each of the wind harnessing apparatuses slows the motion of the wind catch connection, preventing slamming and the production of noise.

14. The advanced wind energy generator as claimed in claim 11 comprises:
the base comprises an electric generator and a gearbox;
the input shaft of the gearbox is operationally connected to the central axis; and,
the output shaft of the gearbox is operationally coupled to the electric generator.

15. The advanced wind energy generator as claimed in claim 11 comprises, wherein the base is rigidly anchored to a surface such as a device, a vehicle, a roof of a building, or to the ground.

16. The advanced wind energy generator as claimed in claim 11 comprises, wherein the flow of ambient air applies a lateral force on the plurality of wind harnessing apparatuses and applies a torque force on the central axis resulting in the central axis.

17. The advanced wind energy generator as claimed in claim 11 comprises, wherein each of the pivot doors rotate into a closed position when in line with the flow of ambient air to create a torque and rotate into an open position when the pivot doors move out of the flow line of ambient air and controlled by gear which is positioned with help of wind catcher angle system.

18. The advanced wind energy generator as claimed in claim 11 further comprises;
A torsion spring between the central axis and the generator assembly;
The torsion spring helps smoothening out the pulses of uneven blowing wind.
